(19) United States
(12) Patent Application Publication
(10) Pub. No.: US 2013/0017421 A1
(43) Pub. Date: Jan. 17, 2013

(54) Battery Pack Safety Techniques

(71) Applicants: Per Onnerud, Framingham, MA (US); Curtis Martin, Westerly, MA (US); Mark Gerlovin, Lexington, MA (US); Phillip E. Partin, Grafton, MA (US); Chad Souza, North Providence, RI (US); Yanning Song, Chelmsford, MA (US); John Warner, Shrewsbury, MA (US); Rui Frias, East Freetown, MA (US); Geoffrey Kaiser, Westborough, MA (US); Eckart W. Jansen, Belmont, MA (US)

(72) Inventors: Per Onnerud, Framingham, MA (US); Curtis Martin, Westerly, MA (US); Mark Gerlovin, Lexington, MA (US); Phillip E. Partin, Grafton, MA (US); Chad Souza, North Providence, RI (US); Yanning Song, Chelmsford, MA (US); John Warner, Shrewsbury, MA (US); Rui Frias, East Freetown, MA (US); Geoffrey Kaiser, Westborough, MA (US); Eckart W. Jansen, Belmont, MA (US)

(73) Assignee: BOSTON-POWER, INC., Westborough, MA (US)

(21) Appl. No.: 13/637,399

(22) PCT Filed: Apr. 1, 2011
(86) PCT No.: PCT/US2011/030985

§ 371 Date: Sep. 26, 2012

Related U.S. Application Data
(60) Provisional application No. 61/320,532, filed on Apr. 2, 2010.

(51) Int. Cl. H01M 2/00; H01M 2/10; H01M 10/48; H01M 10/50

(52) U.S. Cl. 429/61; 429/62; 429/96; 429/90

(57) ABSTRACT

A battery system monitors the status of a battery and ensures safe conditions under a range of events adversely affecting the safety of the battery cells, the battery pack or enclosure, or a vehicle housing the battery. In response to the safety event, the battery system provides one or more responses to secure the battery, disconnect the battery, extinguish a fire, or maintain a safe temperature. Upon detecting the safety event, the a controller activates the safety device accordingly to ensure safe conditions.

### RELATED APPLICATIONS

This application claims the benefit of U.S. Provisional Application No. 61/320,532, filed on Apr. 2, 2010. The entire teachings of the above application are incorporated herein by reference.

### BACKGROUND

Systems for increasing occupant and pedestrian safety in and around moving vehicles such as an automobiles, airplanes, boats, trains or submarines take many forms. Safety in automobiles is of particular concern. More than 1.2 million people die on the world's roads each year and over 50 million others are injured. By year 2030 the 5^{th} leading cause of death will be due to road traffic injuries. Modern automotive safety systems are designed to protect and prevent injury to the occupants of the vehicle, occupants of nearby vehicles and nearby pedestrians in the event of a traffic accident, vehicle malfunction, or driver error. Common automotive safety systems include seatbelts and airbags. As automobiles become increasingly more advanced, additional sensor and actuator electronics form integrated active safety systems that include technologies such as inertial measurement units, night vision and radar.

Battery powered Electric Vehicles (BEV) and Plug-in Hybrid Electric Vehicles (PHEV) are types of automobiles incorporating large batteries for electrical energy storage. According to a recent study, global lithium ion (Li-ion) powered electrical vehicle volumes are expected to grow dramatically through the next decade from under 2 million units in year 2010 to approximately 17 million units in year 2020. With the required BEV average pack capacity at 25 kWh and PHEV capacity at 12.5 kWH, battery packs are large and heavy, and contain considerable amounts of stored electrical energy. When such large amounts of electrical energy are released in an uncontrolled manner, resulting, for example, from an impact delivered during a traffic accident, it can cause a fire, explosion, or electrical shock while placing vehicle occupants and nearby pedestrians in life-threatening danger. Therefore, a need exists for an apparatus and method that overcomes or minimizes the above-referenced problems.

### SUMMARY

The present invention is directed generally to a device and method for reducing the likelihood of damage caused by batteries that are damaged or susceptible to failure in self-propelled vehicles. A safety event can include any condition, such as an impact received during a traffic accident, that may cause damage to the battery system, vehicle, vehicle occupants, or pedestrians around a vehicle.

Example embodiments of the present invention provide for monitoring the status of a battery system and ensuring safe conditions under a range of events adversely affecting the safety of the battery cells, the battery pack or enclosure, or a vehicle housing the battery. In response to the safety event, the battery system provides one or more responses to secure the battery, disconnect the battery, extinguish a fire, or maintain a safe temperature.

In a number of example embodiments, a battery system includes a battery pack, a safety device, and a sensor configured to detect a safety event. The safety event may include one or more of puncture of a battery pack enclosure encompassing the battery pack, deformation of the battery pack enclosure, rapid deceleration, failure of an assembly securing the battery pack, fragmentation of the battery pack, rapid angular acceleration, fire, and temperature above a threshold. Upon detecting the safety event by the sensor, a controller activates the safety device accordingly. The safety device may include, for example, one or more of 1) one or more airbags configured to secure the battery pack upon inflation by an inflation device; 2) one or more airbags configured to sever a power bus upon inflation by an inflation device; 3) an enclosure containing pressurized gas and a controller configured to release the gas at the battery pack; 4) a strap securing the battery within an enclosure, an anchor restricting slackening of the strap in response to a rapid force at the strap; 5) a severing actuator configured to sever the power bus, the actuator including a non-conductive severing edge; and 6) an explosive device configured to sever the power bus.

In further embodiments, the battery system may include a video camera configured to monitor a battery pack. A controller selectively disconnects the battery pack responsive to a safety event indicated by the video camera. The video camera may provide thermal imaging, and the safety event may include detection of a heat region at the battery enclosure. The safety event may also include a deformation of the battery enclosure, or movement of the battery pack relative to the battery enclosure.

In still further embodiments, a battery system may include a battery cell and a temperature sensor at the battery cell. The temperature sensor may be configured to detect temperature of the battery cell and transmit a signal corresponding to the temperature to a battery management system (BMS). The temperature sensor may transmit the signal wirelessly to the BMS, or may transmit the signal via a wireline connection through the terminals of the battery cell. The temperature sensor may be further configured to draw operational power from the battery cell.

In still further embodiments, a battery system may comprise a battery cell, a sensor at the battery cell, and a receiver in communication with the temperature sensor via a common direct current (DC) power bus. The sensor may be configured to detect one or more characteristics of the battery cell and transmit a signal corresponding to the temperature. The sensor may transmit the signal via a DC power bus connected to the terminals of the battery cell, and may be configured to draw operational power from the battery cell. Further, the battery cell may be a lithium-ion cell, and the sensor may measure at least one of temperature, voltage, current, impedance, pressure, stress, strain, acceleration, velocity, position, orientation, or unique cell identifier of the battery cell.

This invention has many advantages. For example, the battery system of the invention can prevent catastrophic rupture of a battery that would cause short-circuiting of the battery or release of electrolyte from the battery. In addition, or alternatively, the battery system of the invention can disconnect a battery from electrical contact to other components during a safety event, such as a high impact caused by collision of a vehicle in which the battery system is installed.

### BRIEF DESCRIPTION OF THE DRAWINGS

FIGS. 1a-d are block diagrams of a battery system of the invention employing an airbag system for electrically isolating battery modules in response to a safety event.

FIG. 1e is a block diagram of a system of the invention providing airbag actuated interruption of a power bus upon detection of a safety event.

FIGS. 2a-b are block diagrams of a battery system of the invention employing a gas-release system in response to a safety event.

FIG. 2c is a block diagram of a system providing release of a gas into a battery pack enclosure upon detection of a safety event.

FIGS. 3a-b are block diagrams of a battery system of the invention and fixture employing an anchored belt.

FIGS. 4a-b are block diagrams of a battery system of the invention employing a shearing device for electrically isolating battery modules in response to a safety event.

FIG. 4c is a block diagram of a system of the invention employing a shearing device to enable severing of a power bus upon detection of safety event.

FIGS. 5a-b are block diagrams of a battery of the invention employing a wireless temperature sensor.

FIG. 5c is a block diagram of battery pack of the invention employing a plurality of wireless temperature sensors.

FIG. 5d is a block diagram of a temperature sensor of the invention.

FIG. 5e is a block diagram of a system of the invention of a plurality of battery packs employing respective temperature sensors.

FIGS. 6a-b are block diagrams of a battery pack employing explosive bolts at a power bus according to an embodiment of the invention.

FIG. 7 is a depiction of a plurality of battery cells linked by a brittle buss bar configured to break at stress concentrator locations during a safety or crash event according to an embodiment of the invention.

FIG. 8 is a diagram of a system of the invention enabling detection of battery compartment movement or deformation, and disconnection of the battery pack in response.

FIG. 9 is a representation to a system of the invention configured to respond to detection of a safety event by triggering chemical passivation.

### DETAILED DESCRIPTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

A description of example embodiments of the invention follows.

Common stationary (unmoving) battery pack systems incorporate several types of safety features and techniques. Often these techniques are designed to disconnect the battery in the event that the battery experiences an unsafe condition. Traditionally, chemical and thermal fuses are used to cut the flow of current at one terminal of the battery if the battery pack is operated at an unsafe current level. Other systems incorporate mechanical- and electromechanical-actuated contactors, which are used to cut the flow of current to one or both battery terminals. Move advanced levels of safety systems are found in notebook computer battery packs. These more advanced systems include voltage, current, temperature and pressure sensors under microprocessor control to aid in the detection of unsafe conditions in the battery pack. Typically such more advanced systems trigger resettable or permanent (non-resettable) fuse devices which cut the flow of current in the main power path to isolate the battery pack. Notebook computer batteries generally store significantly smaller amounts of energy as compared to automotive battery packs.

Battery packs in motion (non-stationary), for example those in motion with a vehicle, require additional safety techniques to insure a safe condition. In addition to the safety techniques required by a stationary battery pack, a battery pack in motion may require many additional safety techniques. This is because a battery pack in motion may experience additional unsafe conditions, or safety events. Some of these additional unsafe conditions may include:
puncture of the battery pack enclosure, electronics assembly, and individual cell enclosures by foreign objects;
deformation or crushing or battery pack compartment, pack enclosure, electronics, or individual cells by foreign objects
high levels of deceleration causing high levels of stress on the pack and cell mounting mechanisms;
failure of pack or cell mounting mechanisms, resulting in pack or cells breaking free and being thrust against the battery compartment walls, interior passenger compartment walls, or being ejected from the vehicle during conditions of rapid deceleration;
pack or cells breaking free having high levels of inertia and could become deformed or crushed upon collision with a compartment wall;
high rates of angular acceleration and deceleration caused by off-center collisions that exert additional forces on the battery pack and its components; and
fire, explosion and high temperatures due to ignition of gasoline fuel in a hybrid type vehicle.

The aforementioned unsafe conditions place particular demands on safety techniques in moving battery packs. With a stationary pack, it is generally acceptable to electrically isolate the energized battery pack from the power bus while electrical energy remains safely stored in the battery pack. With a moving stationary pack, it is not only desirable to electrically isolate the energized pack from the power bus, but also highly desirable to reduce, disable or deactivate the stored energy (state of charge) in the pack and cells to its lowest level. Because automobile accidents occur in time scales on the order of seconds or sub-seconds, the reduction in stored energy must occur on a similar or shorter time scale.

Modern vehicles incorporate increasing amounts of sensor and computing technology in each new model year. Sensors that can detect the onset of an unsafe condition often already exist as part of many vehicle platforms and are used to trigger existing safety systems, such as airbag deployment, seatbelt pretensioning, and anti-lock braking. Some such systems are known as inertial measurement units (IMU) and electronic stability control (ESC). The vehicle platform will in many cases be able to detect a safety event and then transmit a signal to the BMS electronics using the vehicles communication bus. The battery packs can in turn, initiate safety measure for itself when it receives the signal. This type of safety event detection and triggering mechanism results in lower-cost battery packs because sensors do not need to be incorporated in the battery pack.

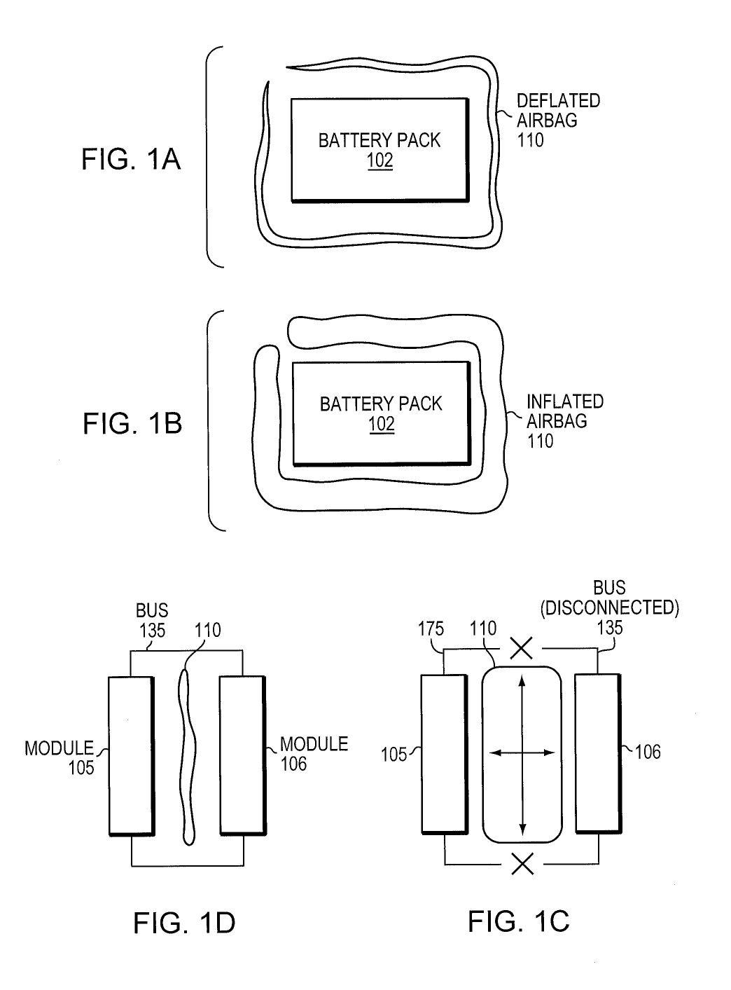

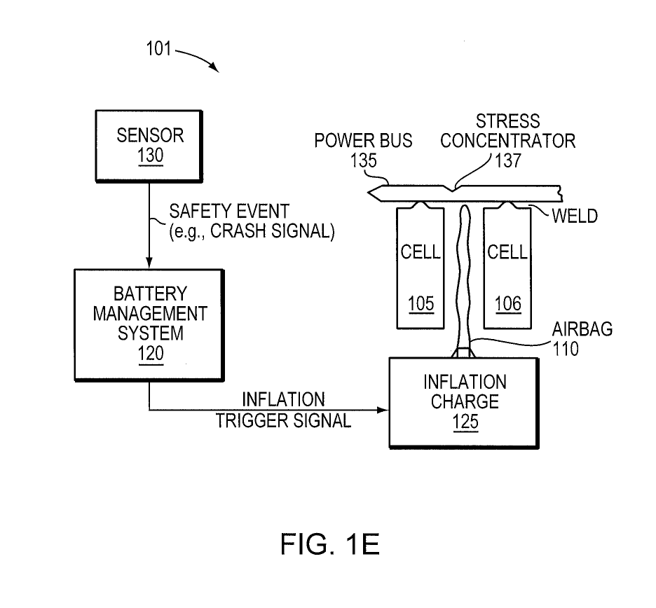

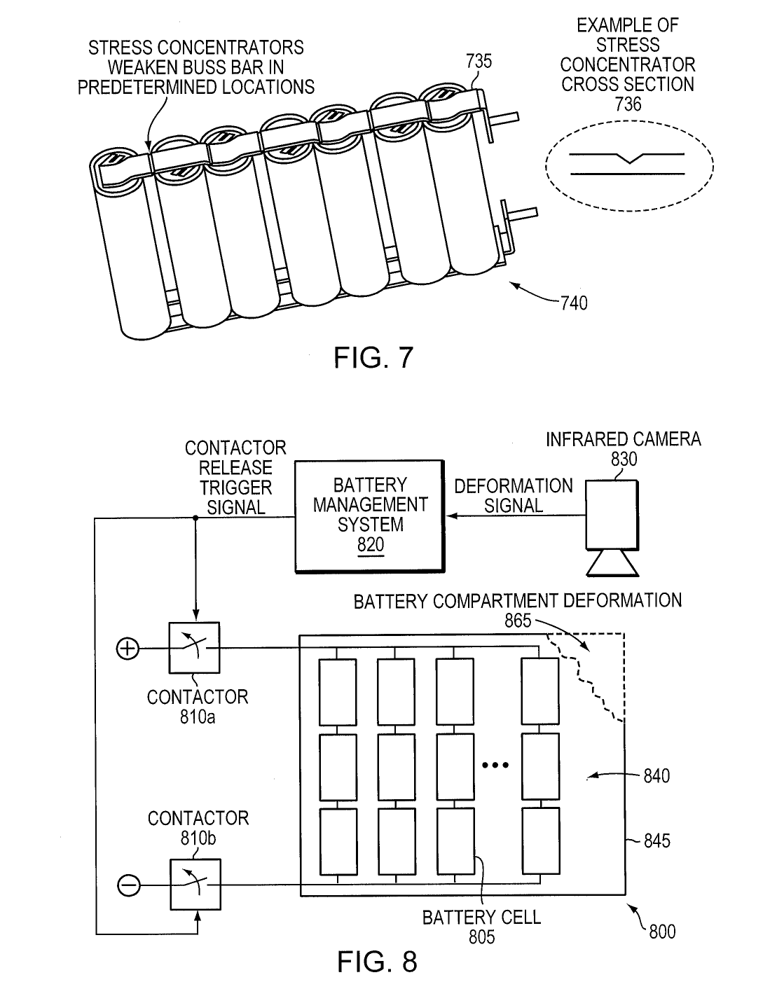

FIGS. 1a-d illustrate, in simplified form, a battery pack airbag system in various configurations. As shown in FIG. 1a, prior to a safety event, an airbag 110 is deflated and encompasses a battery pack 102. Upon detection of a safety event, the airbag 110 is inflated to protect the battery pack as shown in FIG. 1b. In a further embodiment, shown in FIG. 1c, the airbag 110 may be incorporated between multiple battery packs 105, 106 sharing a common power bus 135, or between modules or cells of the same battery pack. When the safety event is detected, the airbag 110 is inflated and causes the battery packs 105, 106 to disconnect, as shown in FIG. 1d. By combining this aspect of the invention with pack bus bar stress concentrations (described below with reference to FIG. 7), the airbag 110 may be used to actuate disconnection of the power buss at the stress concentrator location(s). In this case, a deflated airbag (not shown) may be located between two adjacent cells and in proximity to a stress concentration.

FIG. 1e illustrates a battery system 101 configured to trigger actuation of an airbag during a safety event. When the crash sensor 130 (e.g. accelerometer) or other safety even sensor detects a crash or other safety event, it sends a signal to the battery management system 120 (BMS). The BMS 120 then sends a signal to trigger actuation of an airbag inflation charge 125, which rapidly releases gas into the airbag 110, causing it to expand in the space between two adjacent battery cells 105, 106. As the airbag 110 expands between the cells, a high level of stress occurs at the stress concentrator 137. When the stress exceeds the fracture strength of the bus bar 135 material, the bus bar cracks and electrically disconnects the cells from one another. The weld strengths attaching the cells to bus bar may exceed the fracture strength of the stress concentration on the bus bar to ensure the intended break.

In a further embodiment, the inflating airbag may also operate to disconnect the battery pack from the power bus upon airbag deployment by disconnecting a non-latching type of friction force electrical connector. The electrical connector connects the battery pack to the power bus.

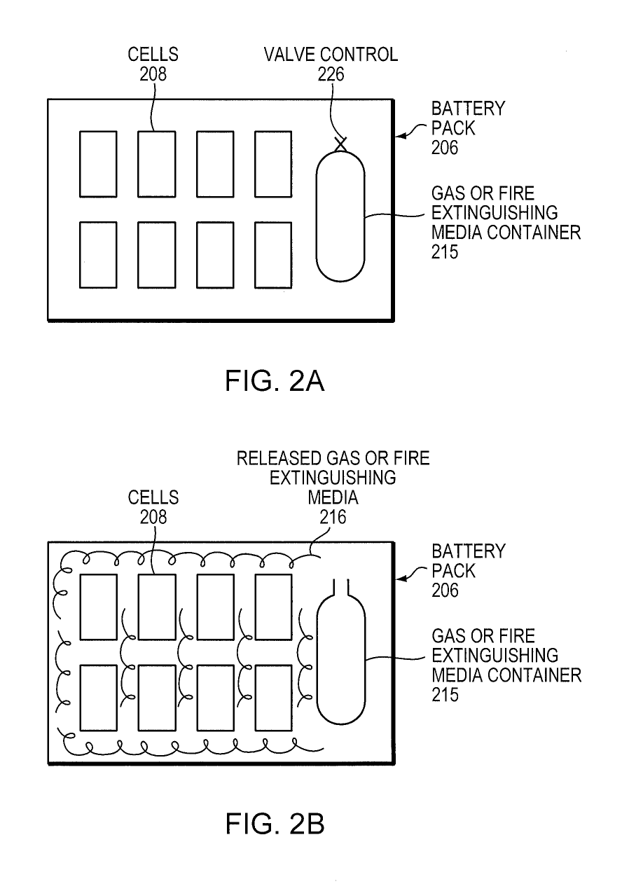

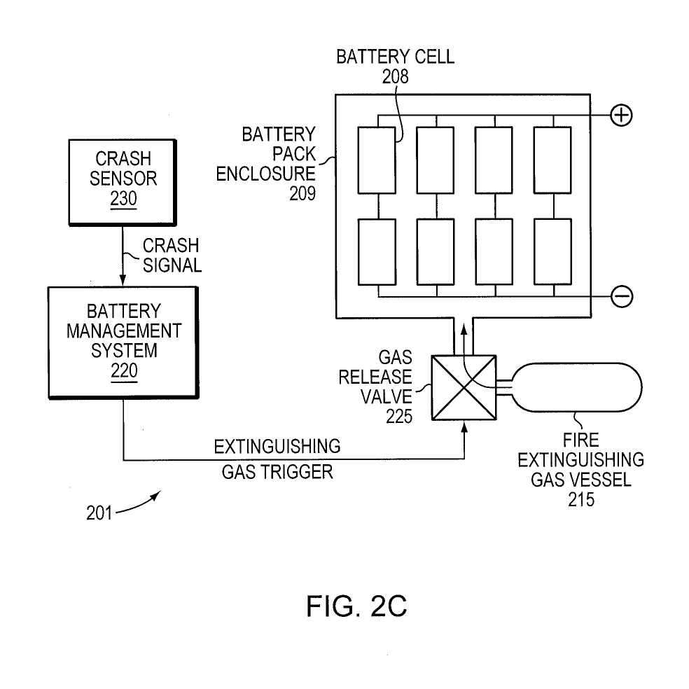

FIGS. 2a-b illustrate a gas release or fire extinguishing system in a further embodiment. Such an embodiment provides a system to respond to detection of a safety event by triggering fast gas injection in the battery. Injection of CO2 gas or fire extinguishing media should be responsive to detection of a fast heat rate or high temperature, smoke, or other catastrophic event. The media injected into battery pack 206 may be selected for the purpose of extinguishing a fire, or to cool the pack. A battery management system may then shut down or disconnect the pack to a safe operation stand-by mode. The pack incorporates a valve-sealed container 215 of gas with a valve control 226 containing fire-extinguishing media as shown in FIG. 2a. After a safety event is detected, the valve is triggered to open and release the gas or fire extinguishing media 216 into the battery pack enclosure, surrounding the battery cells 208 and other modules.

FIG. 2c illustrates a system 201 incorporating a gas-release safety mechanism. A crash sensor 230 (or other safety event detector) detects a crash event and sends a signal to the BMS 220. The BMS 220 sends a trigger signal to actuate an electrically-actuated gas valve 225 into its open position. The gas valve 225 controls the flow of gas from a fire extinguishing gas vessel 215. The fire extinguishing gas rapidly fills the battery pack enclosure 209 containing the battery cells to enhance suppression of a fire or cool the battery cells 208.

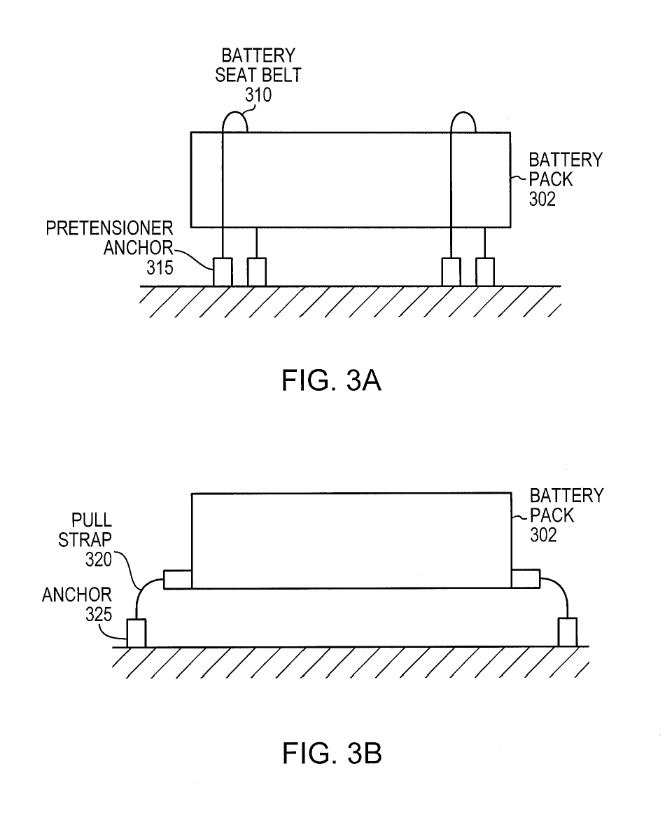

FIG. 3a illustrates a battery pack seat-belt attached to the battery compartment with pretensioning anchors. In such an embodiment, a battery compartment “seat-belt” 310 or pull-strap is used to restrain the battery pack 302 during a safety event. Upon detection of a safety event, the system may trigger the pretensioning (e.g., tightening of the strap or resistance to force on the strap) by the anchor 315 of the battery compartment seat-belt 310 in preparation for an impact other rapid deceleration. FIG. 3b, in a further embodiment, illustrates the battery pack 302 connected to a pull strap 320 tethered to an anchor 325 in a battery enclosure.

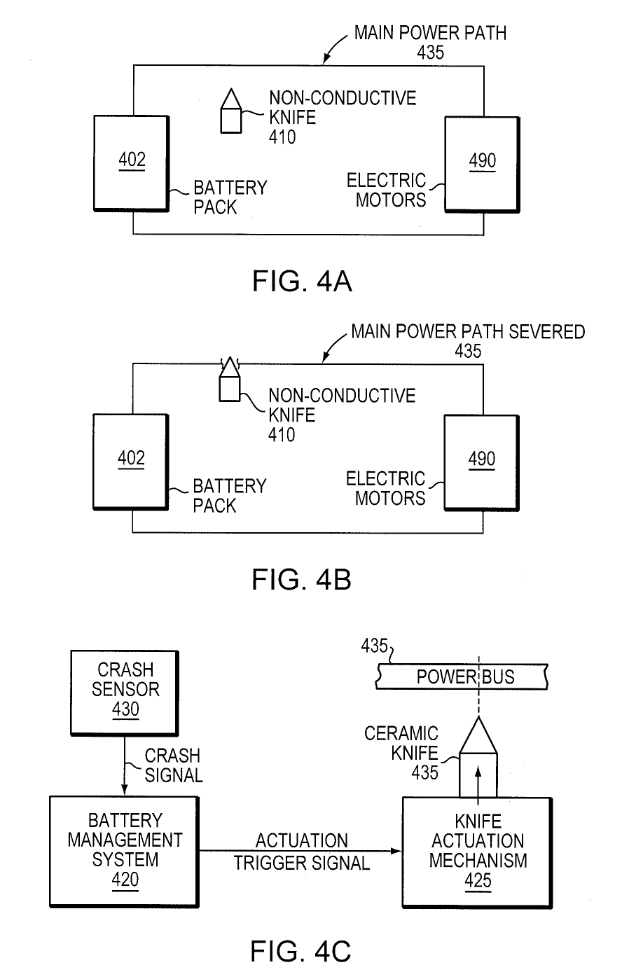

FIGS. 4a-b illustrate a further embodiment, in which a system employs a non-conductive (e.g., ceramic) knife 410 or other severing mechanism. The system responds to detection of a safety event by triggering the non-conductive knife 410 to sever one or more of 1) the main battery power path 435 between a battery pack 402 and an electric motor 490, 2) midway through the pack module chain, and 3) isolating individual modules by severing power bus in multiple locations. It is an objective of one embodiment to prevent electrical shorting of the power path and for this reason a non-conducting type of knife, such as a ceramic knife, is used to mechanically sever the power path. FIG. 4a shows a non-conductive knife with battery pack prior to detection of a safety event. FIG. 4b shows a non-conductive knife with battery pack after detection of a safety event and after severing the main battery power path.

FIG. 4c illustrates an example system that enables actuation of the ceramic knife to sever a power bus 435. A crash sensor 430 (or other safety event sensor) detects a crash condition and emits a signal to the BMS 420. The BMS 420 then sends an actuation trigger signal to the knife actuator mechanism 425, which in turn forces the knife 435 into the power bus 435, thereby severing it and causing an electrical disconnection at the power bus 435. The knife actuator mechanism 425 may be, for example, a linear electromagnetic motor drive, an explosive chemical charge, or a mechanical spring released from a compressed state.

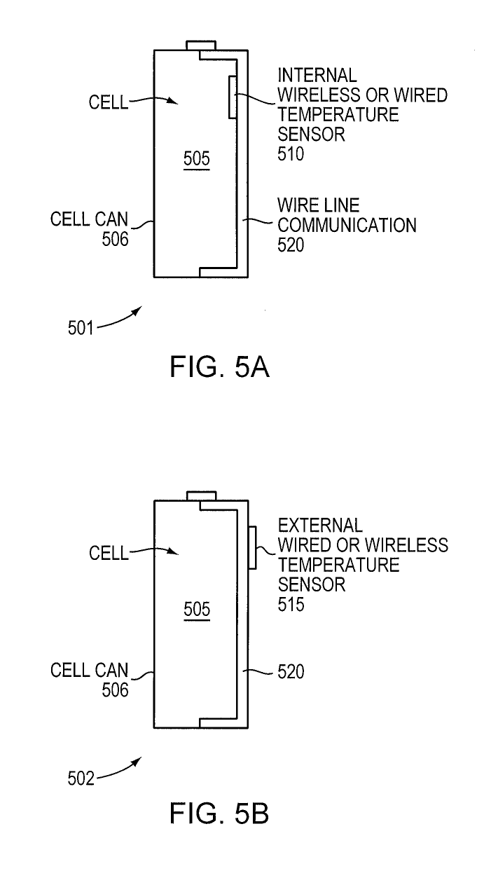

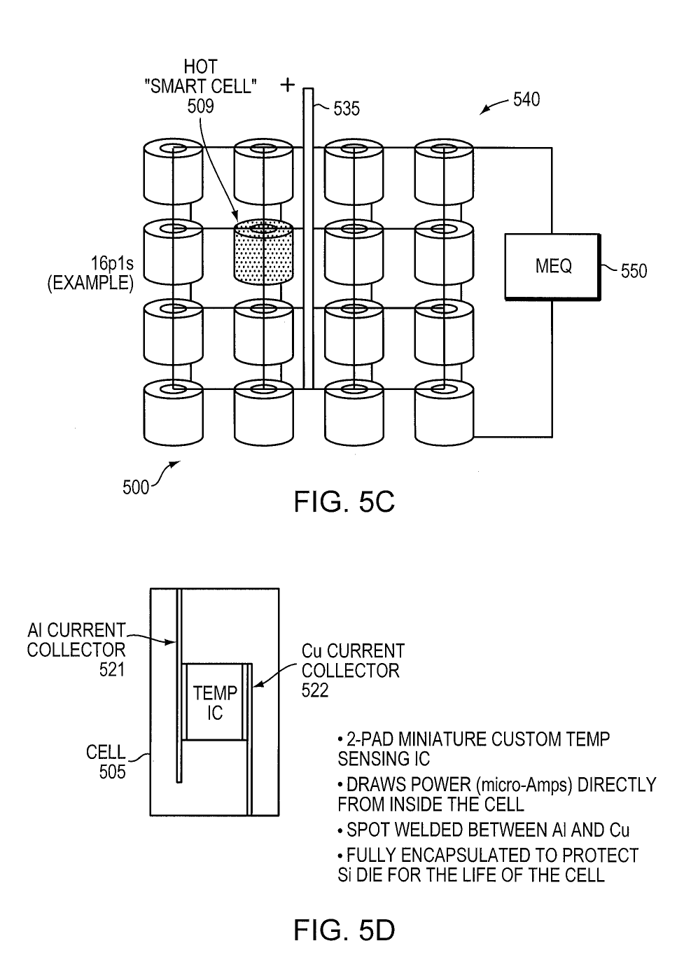

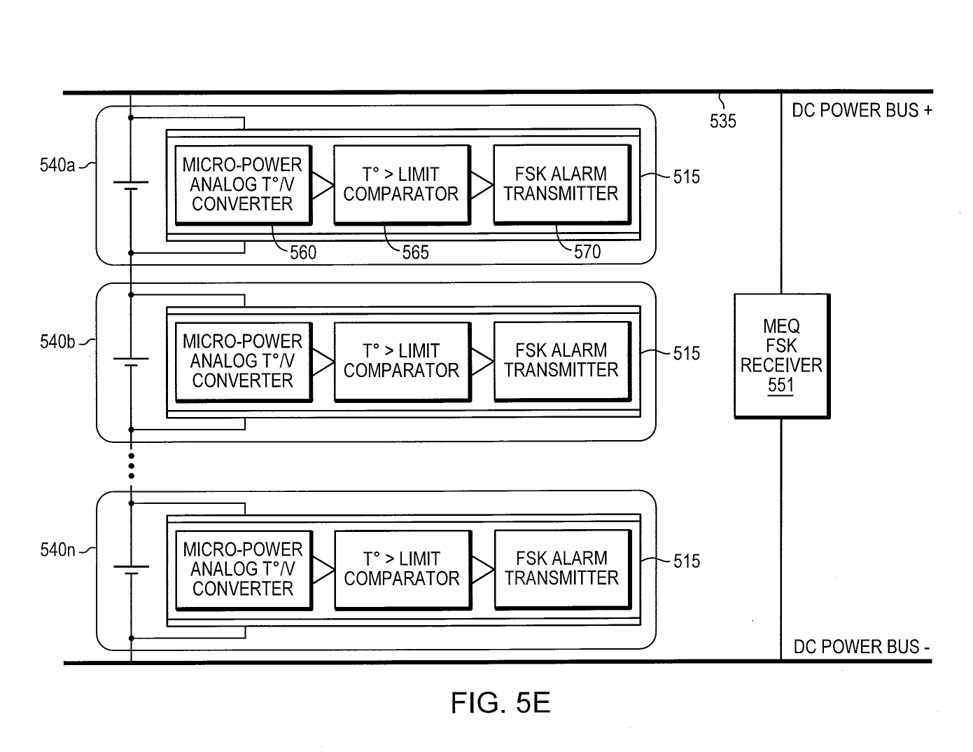

FIGS. 5a-b illustrate a battery cell 505 incorporating a temperature sensor 510, 515 and a wireline 520 connecting to the battery terminals in a further embodiment, providing a system to detect a safety event using low cost, inside-the-cell, wireless or wireline temperature sensor. Such a safety system may provide a fast response to a safety event such as overheating of a battery cell 505, and each cell may be monitored individually without the need for additional wiring. In addition, such as system could reduce the number of back-up external thermistors required for large battery pack blocks and modules. The system may prevent shorting issues inside the cell and for this reason it may be desirable to mount the sensor externally to the cell, in thermal (e.g. welded to can 506 but under the wrapper) contact with the cell can as shown in FIG. 5b. One of several communications methods may be used to communicate between the sensor and control electronics (e.g., a Battery Management System (BMS)), such as wireless Bluetooth® or comparable protocol. Alternatively, a wired configuration may communicate via the same wires that sense the voltage of the block similar to those used in power line communication for remote utility meter reading. Failure modes inside the cell can be mitigated by proper mechanical/electrical design of the sensor IC and attachment methods. The temperature sensor may be fully isolated, on the semiconductor die level, to withstand greater than 30V or more. FIG. 5a shows a wired or wireless sensor integral with the inside the cell can. FIG. 5b shows a wireless or wired sensor attached to the outside of the cell can.

FIG. 5c illustrates a battery system 500 including a battery cell array 540 (e.g., a battery pack) in a further embodiment. Each battery of the array 540 may include a thermal sensor as shown in FIGS. 5a-b, each of which communicates over the DC power bus 535 to provide a simple and low cost method of monitoring safety related parameters of cells 540 within the battery pack. The configuration can reduce or eliminate the number of individual sensors (such as thermistors) and sensor leads between the Measurement and Equalization (MEQ) electronics 550 and the cells.

FIG. 5d illustrates a further embodiment of a thermal sensor at a battery cell 505. Here, a miniature 2-pad custom temperature sensing integrated circuit (IC) is bonded, such as by spot welding, between aluminum and copper electrodes 521, 522 within or outside of the cell 505. The sensing IC can be mounted in a variety of locations within or just outside the battery cell can. For example, the IC could be mounted between opposite electrodes at the top of the spiral within the can. Alternatively the IC could be integrated with the PTC device, or mounted outside the can on the case assembly. The IC draws a small amount of power from the battery to drive its circuitry. The IC silicon die is encapsulated within a protective package that maintains integrity over the lifetime and expected operating conditions of the cell.

FIG. 5e illustrates a battery system implementing a thermal sensor circuit 515 at each battery cell 540a-n, each circuit 515 including a micro-power analog temperature to voltage converter circuit 560 to provide input to a voltage comparator 565. When the temperature reaches a pre-programmed threshold, the comparator triggers an alarm circuit 570. A communication link may be established across the direct-current (DC) power bus 535 between the alarm circuit 570 and a receiver circuit remotely located in the MEQ 551, or alternatively the battery management system (BMS). The transmitter 570 may transmit the alarm condition wirelessly across the DC power bus 535 to the MEQ 551, which proceeds to take an appropriate action.

In a further embodiment, the alarm condition may be transmitted across the DC bus 535 using high frequency pulse sequenced Frequency Shift Keying (FSK). The FSK frequency may be advantageously chosen to work with the cell/bus-bar self-inductance thereby reducing or eliminating components in the transmitter circuit. The IC may contain identification tag capabilities to enable location of the overheated cell. Each IC may contain a unique, for example given in 32-bits, identification number. When a given cell identifies itself, a lookup table relating the IC identifier to its cell location within the battery pack is used to identify the cell's location. Further, a receiver may be incorporated into the IC to enable bi-directional communication between the MEQ and cell. The MEQ may query individual cells to obtain about their presence, physical parameters, and safety device status. Similarly the MEQ may instruct individual cells to electrically isolate themselves from the power bus, discharge them-selves or to electrically bypass themselves. In a related embodiment, communication occurs directly between cells or groups of cells without intervention of the MEQ. Individual cells may compare or poll measured temperature levels between one another and take action independently without intervention of the MEQ.

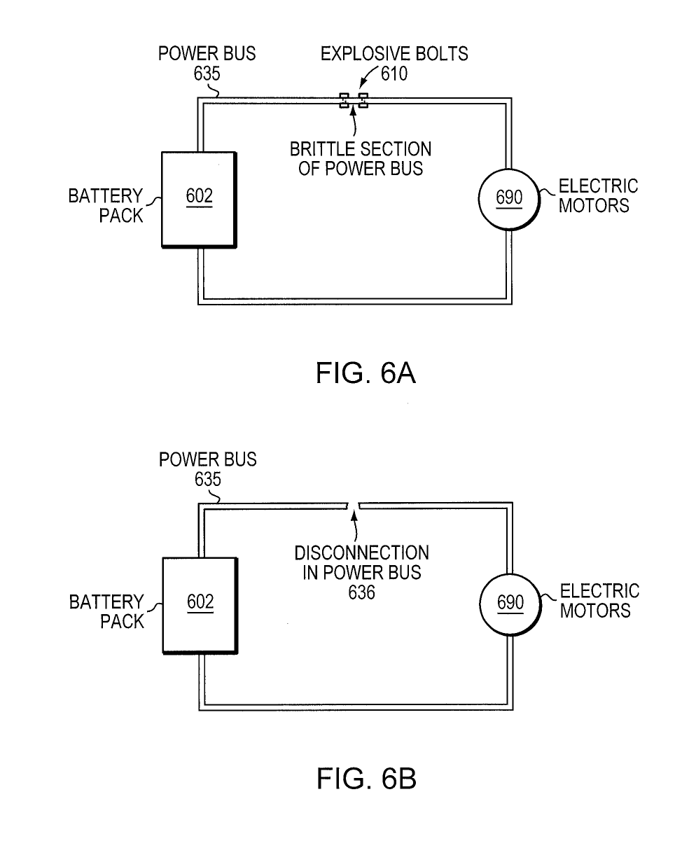

FIG. 6a illustrates a battery pack 602 with power bus 325 prior to a safety event, the power bus 635 incorporating a brittle power bus section and explosive bolts 610. FIG. 6b illustrates the battery pack with power bus after a safety event has caused explosive bolts 610 to fracture and disconnect the battery pack 602 from the electric motor 690 along the power bus 635. The bolts 610 have a shear plane where externally applied force is used break them in two, allowing separation. One mechanism for detonation is by using a commonly known NASA Standard Initiator (NSI) device. The resulting force is applied through the bolt in the form of a shockwave that breaks at the pre-defined shear plane. When the bolts break, the power bus separates to disconnect the electrical path.

In further embodiments, alternative safety mechanisms, or a combination of safety mechanisms, may be employed to disrupt the power bus (or a battery connection to the power bus) in response to a safety event. For example, in addition to the exploding bolts 610 described above, a fast-acting contactor or thermal fuse using a chemical reaction (explosion) may be triggered to break the power bus. Alternatively, a mechanism may shatter a brittle conductive section of the power bus, such as a blunt object constructed from metallic ceramic material, thereby disconnecting the power bus. A controlled mechanical separation and dis-integration of the battery pack may be actuated at selected connecting points. Separated components would thereby be electrically disconnected. Pressurized gas may be released to selectively fracture mechanically weakened sections (e.g., pneumatic fuse) in the power bus to disconnect and isolate the power bus.

FIG. 7 illustrates a further embodiment of a battery pack 740 employing a power bus 734 having a number of stress concentrators for facilitating predictable breaking of the power bus 735 in response to a safety event. It is advantageous in a vehicle crash to quickly disconnect each battery cell and lower the voltage and currents available to shorts. The battery pack 740, in employing stress connectors 736, may enable disconnection of the constituent cells due to the mechanical force on the power bus 735. Such a disconnection may therefore be actuated without a safety event (e.g., crash) sensor and switches to disconnect the cells. By mechanically weakening the cell electrical connections, the crash force will break the pieces, resulting in disconnected cells, lower voltages, and current. The stress concentrators 736 (e.g. notches) weaken the power buss bar. Materials selected for the bus bar must be brittle, yet maintain high conductivity. Possible material may include types of conducting ceramic materials or composite layers of ceramic and thin metal (e.g. copper) films. In a further embodiment, a plurality of lever- or mass-actuated systems may be attached to the buss bar to apply local forces using crash acceleration to improve (faster, at lower acceleration level, or preferred crash acceleration directionality) actuation of the cracking mechanism at the stress concentrators.

FIG. 8 illustrates a system 800 in a further embodiment to detect a safety event by configuring a battery compartment with a camera 830. In alternative embodiments, a radar, visible light or infrared sensor may be implemented. The camera 820, in conjunction with a BMS 820, may detect movement of a battery pack 840 relative to a respective battery enclosure 845, or a change in shape of the enclosure 845 such as by crushing (e.g., a deformation 865). The system employs an infrared camera and provides electrical disconnection of the battery pack from the vehicle by releasing contactor switches. The infrared camera may detect a crushing (resulting from a crash condition) in the battery compartment. It sends a deformation signal to the BMS. The BMS then sends contactor release trigger signals to the contactors which electrically disconnect the battery pack from the power bus of the vehicle.

Another example embodiment provides a system using an infrared camera 830 to detect heat in large areas in and around the battery pack 840 and enclosure 845. The use of cameras 830 enables larger areas to be scanned for heat detection purposes and detect any hotspots that can be created. Upon detection of hot spots, the battery management system 820 may then shut down or disconnect the pack 840 to place it in a safe operation stand-by mode.

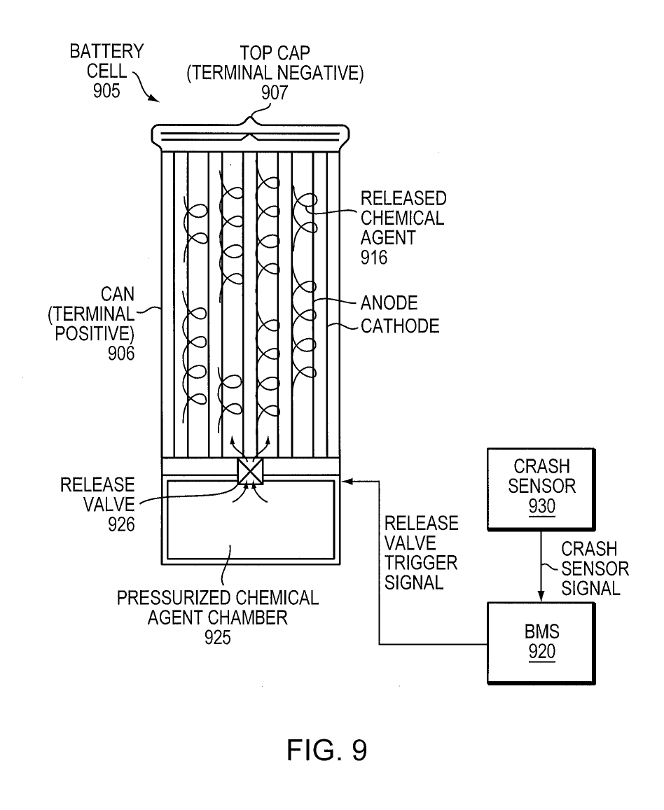

FIG. 9 illustrates a system configured to respond to detection of a safety event by triggering the chemical passivation (lowering state of charge) of individual battery cells. Chemical passivation of battery cells may be accomplished using one or a combination of the following methods:
injection of a wax chemical agent into cell to form a barrier layer between anode and cathode, inhibiting or reducing ion mobility across the cell;
injection an electro chemical agent compound which will act to passivate the anode or cathode of each cell by preferentially binding to charged ion sites;
injecting or activating an existing chemical agent compound which will solidify the electrolyte to inhibit or prevent ion mobility across the cell;
initiating a phase change in the electrolyte to inhibit or prevent ion mobility across the cell, such as by freezing the pack; and
discharging excess electrical energy into a thermoelectric cooler (Peltier effect) device in close proximity to the cell to rapidly cool/freeze the electrolyte.

As shown in FIG. 9, a battery cell 905 includes a can 906, top cap 907 and is fitted with a chemical agent chamber 926. When the crash sensor 930 detects a crash or other safety even, it sends a crash sensor signal to the BMS 920. The BMS 920 in turn sends a release valve trigger signal to open the release valve 926 to the chemical agent chamber 925. Actuation of the release valve causes a chemical agent 916 to move from the pressurized chemical agent chamber through the open valve and into the battery cell, between, surrounding, and mixing with the anode, cathode and electrolyte within the cell can 906. The chemical agent 916 may act to passivate and lower battery cell state of charge in one or more of the methods described above.

Another embodiment provides a system to respond to the detection of a safety event using a mechanism that moves the battery pack to a safer position within an enclosure. It is an objective of the invention when dropping the pack to simultaneously disconnect the battery from the power bus.

Another embodiment provides a system to respond to the detection of a safety event by using a mechanism to release and eject the battery upward, laterally sideways, beneath, forward, or backward out and away from the moving vehicle. Additional means on the moving pack to secure a safe controlled stop such as encapsulating airbag, tether to vehicle, wheels, wings, or parachute.

Another embodiment provides a system to respond to detection of a safety event using a wedge shaped mechanism to force battery pack up during impact and disconnect it from power bus.

Another embodiment provides a system to respond to detection of a safety event by triggering deployment of an airbag underneath the battery pack, thereby pushing the battery pack into a safe position. It is an objective of the invention to simultaneously disconnect the battery pack from the power bus upon airbag deployment.

Another embodiment provides a system to respond to detection of a safety event by triggering deployment of expanding foam in close proximity to the battery pack to suppress fire in the vicinity of the battery and to encapsulate it. An example of types of commercially available foam that may be used the commercial type Tundra® for fire suppression. An example system for deployment of the foam would be similar to the gas extinguishing system shown in FIG. 2c. However, instead of a gas containing vessel, a pressurized foam-containing vessel would be used in the system. Upon detection of a crash event, the crash sensor sends a signal to the BMS. The BMS sends a trigger signal to a foam release valve which opens to enable pressurized foam to be released into the battery enclosure. The foam would act to suppress any fire in the vicinity of the battery cells.

Another embodiment provides a battery pack with reinforced enclosure constructed from puncture resistant material such as commercially available Kevlar. It is an objective of the invention to prevent puncture of the battery pack during a safety event.

Another embodiment provides a battery pack enclosed by and surrounding cavity filled with a chemical compound. When the surrounding cavity is punctured such as during a safety event, chemical compound is released in the vicinity of the battery pack to serve at least one of the following functions: 1) suppress fire, 2) absorb excess heat, 3) chemically passivate cells, 4) mechanically stabilize pack, and 5) sever or electrically short power bus terminals.

Another embodiment provides a system to respond to detection of a safety event by triggering the fast discharge of electrical energy remaining in the pack in a safe and controlled manner, thereby reducing pack state-of-charge for increased safety. Some of the possible safe and controlled discharge techniques are one or a combination of the following:
mechanically brake vehicle by running wheel motors in reverse;
discharging through the regenerative brake's bleed resistor;
using electrical energy to trigger inflation of airbags for battery or occupant safety;
using an electrolysis chemical reaction to generate a gas which is used to inflate an airbag thereby lowering battery state of charge;
discharging through a car chassis or parts of the car frame, preferably with log resistive path way;
controlling the discharge rate using a resistor;
using the vehicle engine liquid cooling system to cool the battery pack;
discharging electrical energy into a power resistor thermally coupled to vehicle radiator or another part of the liquid cooling system;
discharging electrical energy by converting it to acoustic energy in a selected combination of frequencies which match the resonant modes of the vehicle frame and chassis resulting in rapid absorption of the energy;
discharging electrical energy directly to an earth ground;
ejecting electrodes connected to pack terminals into the nearby earth for discharge through the ground material; and
ejecting electrodes connected to pack terminals into nearby water, lake, stream for discharge through the water.

Another embodiment provides a system incorporating a phase-change material in its voids or otherwise in the pack's enclosure which, during a safety event, absorb heat generated around or by the battery pack in a material phase transformation.

Another example embodiment provides a system to detect battery pack safety event using an integrated automotive “crash” sensor (accelerometer or gyroscope rate sensor) directly inside the battery pack. This approach adds an additional level of safety system redundancy over receiving this signal remotely from the central automobile inertial measurement unit.

Another embodiment provides a system to respond to detection of a safety event by selectively triggering alternate parallel cells or parallel modules within the battery pack to disconnect and reconnect with reverse polarity. It is an objective of this invention to cause controlled discharge of energy between the parallel elements, thereby lowering state-of-charge of the battery pack and placing it in a safer energy state. The controlled discharge is monitored and controlled in a manner to prevent initiating a thermal run-away which could place the pack in an unsafe condition. Another embodiment provides a system to respond to detection of a safety event by remotely triggering all charge interrupt devices (CID) in all pack cells to an open circuit condition simultaneously, thereby simultaneously disconnecting all cells from the power bus. Various triggering mechanisms are possible including the following:
remote triggering mechanism for actuating all CID devices using magnetic field to open the CID; and
remote triggering mechanism for actuating all CID devices using pneumatically by releasing a pressurized gas through flow channels and uni-directional valves into the cell cans thereby resulting in pressure increase in the can to trigger the CID.

While this invention has been particularly shown and described with references to example embodiments thereof, it will be understood by those skilled in the art that various changes in form and details may be made therein without departing from the scope of the invention encompassed by the appended claims.

What is claimed is:

1. A battery system comprising:
a battery pack;
at least one airbag proximate to the battery pack, the at least one airbag configured to secure the battery pack upon inflation;
an inflation device connected to the airbag; and
a sensor connected to the inflation device, the sensor configured to detect a safety event and, in response, transmit a signal to activate the inflation device.

2. The battery system of claim 1, wherein the airbag, upon inflation, disconnects the battery pack from a power bus. 15

3. The battery system of claim 1, wherein the safety event includes one or more of puncture of a battery pack enclosure encompassing the battery pack, deformation of the battery pack enclosure, rapid deceleration, failure of an assembly securing the battery pack, fragmentation of the battery pack, rapid angular acceleration, fire, and temperature above a threshold.

4. A battery system comprising:
at least two battery modules connected to a common power bus;
at least one airbag configured between the at least two battery modules, the at least one airbag configured to sever the power bus upon inflation;
an inflation device connected to the airbag; and
a sensor connected to the inflation device, the sensor configured to detect a safety event and, in response, transmit a signal to activate the inflation device.

5. A battery system comprising:
a battery pack comprising a plurality of cells;
an enclosure containing pressurized gas; and
a controller configured to detect a safety event and, in response to the safety event, release the pressurized gas to the plurality of cells.

6. The battery system of claim 4, further comprising a battery enclosure encompassing the battery pack, the battery enclosure configured to contain the pressurized gas upon release.

7. A battery system comprising:
a battery enclosure housing at least one battery pack;
a video camera configured to monitor the battery pack; and
a controller configured to detect a safety event associated with the enclosure and, responsive to the safety event, disconnect the at least one battery pack from a power terminal.

8. The battery system of claim 6, wherein the video camera provides thermal imaging, and wherein the safety event includes detection of a heat region at the battery enclosure.

9. The battery system of claim 6, wherein the safety event includes detection of a deformation of the enclosure.

10. The battery system of claim 6, wherein the safety even includes detection of movement of the at least one battery pack relative to the battery enclosure.

11. A battery system comprising:
a battery pack;
a battery enclosure housing the battery pack;
a strap configured to secure the battery pack within the enclosure; and
an anchor connected to the strap, the anchor configured to restrict slackening of the strap in response to a rapid force at the strap.

12. A battery system comprising:
a battery pack;
a power bus connecting to the battery pack;
a severing actuator adjacent to the power bus; and
a controller configured to detect a safety event and, in response to the safety event, activate the severing actuator to sever the power bus.

13. The battery system of claim 10, wherein the severing actuator contains a non-conducting severing edge.

14. A battery system containing:
a battery pack;
a power bus connected to the battery pack;
an explosive device at the power bus; and
a controller configured to detect a safety event and, in response to the safety event, activate the explosive device to sever the power bus.

15. A battery system, comprising:
a battery cell;
a temperature sensor at the battery cell, the temperature sensor configured to detect temperature of the battery cell and transmit a signal corresponding to the temperature; and
a battery management system in communication with the temperature sensor.

16. The battery system of claim 14 wherein the temperature sensor transmits the signal wirelessly to the battery management system.

17. The battery system of claim 14 wherein which the temperature sensor transmits the signal via a DC power bus connected to the terminals of the battery cell.

18. The battery system of claim 14 wherein the temperature sensor is configured to draw operational power from the battery cell.

19. A battery system, comprising:
a battery cell;
a sensor at the battery cell, the sensor configured to detect one or more characteristics of the battery cell and transmit a signal corresponding to the temperature; and
a receiver in communication with the temperature sensor via a common direct current (DC) power bus.

20. The battery system of claim 14 wherein which the sensor transmits the signal via a DC power bus connected to the terminals of the battery cell.

21. The battery system of claim 14 wherein the sensor is configured to draw operational power from the battery cell.

22. The battery system of claim 19 wherein the sensor measures at least one of temperature, voltage, current, impedance, pressure, stress, strain, acceleration, velocity, position, orientation, or unique cell identifier of the battery cell.

23. The battery system of claim 19 wherein the battery cell is a lithium-ion cell.
